(19) United States
(12) Patent Application Publication
(10) Pub. No.: US 2007/0053255 A1
(43) Pub. Date: Mar. 8, 2007

(54) Optical pickup apparatus

(75) Inventors: Yuichi Atarashi, Tokyo (JP); Takeshi Kojima, Tokyo (JP); Kazutaka Noguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/514,166

(22) Filed: Sep. 1, 2006

(30) Foreign Application Priority Data
Sep. 5, 2005 (JP) 2005-256400

(51) Int. Cl. G11B 7/00

(52) U.S. Cl. 369/44.23

(57) ABSTRACT

An optical pickup apparatus having first and second light sources emitting first and second light fluxes having wavelength of λ1 and λ2, respectively, an light-converging optical system including first and second objective optical elements, and a lens holder to hold the first and second objective optical elements. When the optical pickup apparatus converges the first or the second light flux onto first or second information recording surface of first or second information recording medium through one protective substrate, which has a thickness of t1 or t2 and is provided on the first or second information recording surface, with utilizing the first or second objective optical element for conducting information recording and/or information reproducing of the first or second information recording medium, a variation of each of a coma aberration and an astigmatism is not more than 0.02 λ1 rms or 0.02 λ2 rms, respectively.

### TECHNICAL FIELD

The present invention relates to an optical pickup apparatus, and more particularly to an optical pickup apparatus capable of information recording and/or information reproducing to different optical information recording media by converging light fluxes emitted from light sources having light source wavelengths different from each other through either of two objective optical elements.

### BACKGROUND ART

In recent years, research and development of a high density optical disc system capable of information recording and/or information reproducing using a blue-violet semiconductor laser having a wavelength of about 400 nm have been rapidly advancing. As an example, in an optical disc performing information recording and/or information reproducing in the specifications of a numerical aperture (NA) of 0.85 and a light source wavelength of 405 nm (hereinafter such an optical disc is referred to as a “high density Digital Versatile Disc (DVD)” in the present specification), a recording of information of from 20 GB to 30 GB per surface can be performed to an optical disc with a diameter of 12 cm, which is the same size as that of a DVD (having an NA of 0.6, a light source wavelength of 650 nm, and a storage capacity of 4.7 GB).

Now, only the possibility of information recording and/or information reproducing suitable to such a high density DVD is not enough to have a sufficient value as a product of an optical pickup apparatus. When taking the present state in which DVD's and compact discs (CD's) which record various information are sold, into consideration, it is not enough to be able to record and/or reproduce information suitably on a high density DVD, but it is lead to enhancing the value of a product as a compatible type optical pickup apparatus to configure the optical pickup apparatus to be able to suitably record and/or reproduce to a conventional DVD or a conventional CD possessed by a user as well, for example. From such a background, a light-converging optical system to be used for a comparative type optical pickup apparatus is desired to have a performance capable of performing suitable information recording and/or suitable information reproducing to any of the high density DVD and the conventional type DVD and CD, with keeping compatibility.

Here, in order to simplify the configuration of the optical pickup apparatus and to attain lowering the cost thereof, it is preferable to configure a light-converging optical system including an objective lens to be single even in the optical pickup apparatus having the compatibility, property speaking. However, because the objective lens is required to have an extremely high aberration characteristic in information recording and/or information reproducing to a high density DVD owing to changes of the light source wavelengths to be shorter ones and adoption of a high NA, it is sometimes difficult to suitably perform the information recording and/or the information reproducing to a DVD and a CD using the same object lens. On the other hand, an example of an optical pickup apparatus which can perform information recording and/or information reproducing to three or more kinds of optical information recording media by changing a plurality of objective lenses to be used is described in, for example, JP 2004-319062A.

In order to suitably perform information recording and/or information reproducing in an optical pickup apparatus, it is necessary to suitably converge a light flux having passed through an objective optical element onto a track on the information recording surface of an optical information recording medium (an optical disc), and consequently a focusing operation and a tracking operation to perform the positioning of the objective optical element are needed. Here, it is sufficient for a general DVD/CD compatible type optical pickup apparatus, for example, to perform the focusing operation and the tracking operation of an objective optical element to be commonly used, and consequently a small-sized type actuator for the objective optical element can be used.

However, in the case of using two objective optical elements as shown in the JP 2004-319062A, the need of performing the focusing operations and the tracking operations of the respective objective optical elements arises. When actuators are separately provided to them to drive them independently, increase of the number of the actuators causes complexity of the configuration of the optical pickup apparatus and enlargement of the size thereof. Furthermore, there is also a situation in which it is unnecessary to drive the objective optical elements independently because, while one of the objective optical elements is used, the other objective optical element is not used.

Accordingly, a configuration of holding two objective optical elements with a common supporting member and driving the common supporting member with a common actuator was planned. However, in the configuration of driving the two objective optical elements together with the common supporting member, a larger driving force becomes necessary for the actuator in order to perform the focusing operation and the tracking operation with a good response to the increase of the inertia mass of the load of the actuator. Because the conducting quantity becomes larger for acquiring the larger driving force, a heat value also becomes larger, and the existence of a problem in which the objective optical elements are heated by the generated heat which has been transmitted through the supporting member becomes clear. Moreover, the existence of another problem in which a deviation arises in the temperature distribution on the optical surfaces of the objective optical elements based on the relation between the arrangement of the actuator and the arrangement of the two objective optical elements also becomes clear. When a temperature difference becomes excessive in the temperature distributions in the direction perpendicular to the optical axis in each of the objective optical elements and/or the optical axis direction thereof, it is apprehended that thermal expansions of the optical surfaces are caused and aberration deterioration impeding the suitable information recording and/or the suitable information reproducing is caused. In particular, in recent years, there has been a requirement of increasing the speed of performing the information recording and/or the information reproducing of the optical information recording medium, and it is necessary to suppress the aberration deterioration of the light flux having passed through each of the objective optical elements in order to respond to the requirement.

### SUMMARY

The present invention has been accomplished in view of these problems. It is an object of the invention to provide an optical pickup apparatus capable of performing information recording and/or information reproducing suitably to different optical information recording media by using two objective optical elements.

A first embodiment of the invention is an optical pickup apparatus. The optical pickup apparatus comprises a first light source emitting a first light flux having wavelength of λ1, a second light source emitting a second light flux having wavelength of λ2, an light-converging optical system including a first objective optical element and a second objective optical element, and a lens holder to hold the first objective optical element and the second objective optical element. The first objective optical element is arranged in parallel with the second objective optical element so as to differ an optical axis of the first objective optical element from an optical axis of the second objective optical element, and at least one of the first objective optical element and the second objective optical element is a plastic lens.

In the optical pickup apparatus of the first embodiment, when the optical pickup apparatus converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium, a variation of each of a coma aberration and an astigmatism is not more than 0.02 λ1 rms.

Further, when the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium, a variation of each of a coma aberration and an astigmatism is not more than 0.02 λ2 rms.

It is considerable that the temperatures of the objective optical elements are adjusted to be always within a predetermined range with temperature adjustment means as a technical idea for performing information recording and/or information reproducing suitably even when the first objective optical element and the second objective optical element are heated by a heat source such as an actuator. However, for example, in the optical pickup apparatus installed in a notebook-size personal computer and the like, it is difficult to separately provide the bulky temperature adjustment means owing to the restriction of a space or the like. On the other hand, there is a technical idea of previously giving an optical surface shape generating a good aberration in the state of the generation of a temperature distribution to each o f the optical elements as another technical idea. However, the temperature distribution at the transient time of becoming a steady state from a power activation is not fixed, and the temperature distribution changes every moment. Moreover, there is the possibility that the temperature distribution changes even in the steady state under a different outside air temperature environment. As a result, it is difficult to acquire an optical surface shape generating an always good aberration to the temperature distribution changing variously like this.

As a result of a keen examination of the problems from another viewpoint by the inventors of the present application, we have found that it is possible to perform information recording and/or information reproducing suitably to an optical information recording medium, for example, by skew adjustment, which tilts each of the objective optical elements to the optical axis thereof, when the changes of a coma aberration and an stigmatism are severally suppressed to be within a fixed range (i.e. ±0.02 λ1 rms or less, or ±0.02 λ2 rms or less) during a period of a change of the temperature distribution of the optical surface of each of the objective optical elements before used, to the temperature distribution when used. Here, there are a method of using an objective optical element capable of suppressing aberration changes even if a temperature distribution arises, a method of suppressing the deviation of a temperature distribution arising in the direction perpendicular to the optical axis in the inside of an objective optical element, and the like as the methods of suppressing the deterioration of the spherical aberration, the coma aberration and the astigmatism to be within a range of ±0.02 λ1 rms or less, or ±0.02 λ2 rms or less.

A second embodiment of the invention is an optical pickup apparatus. The optical pickup apparatus comprises a first light source emitting a first light flux having wavelength of λ1, a second light source emitting a second light flux having wavelength of λ2, an light-converging optical system including a first objective optical element and a second objective optical element, and a lens holder to hold the first objective optical element and the second objective optical element. The first objective optical element is arranged in parallel with the second objective optical element so as to differ an optical axis of the first objective optical element from an optical axis of the second objective optical element, and at least one of the first objective optical element and the second objective optical element is a plastic lens.

The optical pickup apparatus of the second embodiment converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium, and the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium.

Further, in the optical pickup apparatus of the second embodiment, the lens holder comprises a internal holding member to directly hold the first and second objective optical elements and a external holding member to hold the internal lens holding member, and a heat conduction ratio of the internal holding member and a heat conduction ratio of the external holding member is different from each other.

In the optical pickup apparatus of the second embodiment, the heat conduction ratios of the internal holding member and the external holding member differ from each other in the lens holder. For example, when the heat conduction ratio of the external holding member is lower, the heat from a heat source is shielded by the heat shield function of the external holding member. Consequently, the quantity of the heat transmitted to the internal holding member touching the objective optical elements directly decreases, and the heat diffuses in the external holding member to be uniformly transmitted to the internal holding member. Because the transmitted heat is radiated in the internal holding member and is diffused to be transmitted in the external holding member, the heat is uniformly transmitted to the objective optical elements. By such a configuration, the deviation and the highest temperature of a temperature distribution generated on the optical surface of each of the objective optical elements can be suppressed, and the change of the aberration caused by a temperature change can be suppressed as a result. Moreover, when the heat conduction ratio of the internal holding member is lower, the heat from the heat source is radiated in the external holding member. Furthermore, by the heat shield function of the internal holding member, the heat transmission to each of the objective optical elements is suppressed, and by the diffusion of the heat transmitted into the internal holding member to be uniformly transmitted to each of the objective optical elements, the deviation and the highest temperature of a temperature distribution generated in the optical surface thereof can be suppressed. As a result, the changes of the aberration caused by the temperature changes can be suppressed.

A third embodiment of the invention is an optical pickup apparatus. The optical pickup apparatus comprises a first light source emitting a first light flux having wavelength of λ1, a second light source; emitting a second light flux having wavelength of λ2, an light-converging optical system including a first objective optical element and a second objective optical element, and a lens holder to hold the first objective optical element and the second objective optical element. The first objective optical element is arranged in parallel with the second objective optical element so as to differ an optical axis of the first objective optical element from an optical axis of the second objective optical element, and at least one of the first objective optical element and the second objective optical element is a plastic lens.

The optical pickup apparatus of the third embodiment converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium, and the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium.

Further, in the optical pickup apparatus of the third embodiment, the lens holder has a radiating fin.

Because in the optical pickup apparatus of the third embodiment, the lens holder is equipped with the radiating fin, the heat radiation is performed before the heat from a heat source has been transmitted to each of the objective optical elements, and consequently the heat quantity transmitted to each of the objective optical elements is decreased. Thereby, the deviation and the highest temperature of a temperature distribution generated on the optical surface of each of the objective optical elements can be suppressed, and the changes of the aberration caused by the temperature changes can be suppressed as a result.

A fourth embodiment of the invention is an optical pickup apparatus. The optical pickup apparatus comprises a first light source emitting a first light flux having wavelength of λ1, a second light source emitting a second light flux having wavelength of λ2, an light-converging optical system including a first objective optical element and a second objective optical element, and a lens holder to hold the first objective optical element and the second objective optical element. The first objective optical element is arranged in parallel with the second objective optical element so as to differ an optical axis of the first objective optical element from an optical axis of the second objective optical element, and at least one of the first objective optical element and the second objective optical element is a plastic lens.

The optical pickup apparatus of the fourth embodiment converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium, and the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium.

Further, in the optical pickup apparatus of the fourth embodiment, the lens holder has a radiating means for reducing heat transfer from an external heat source to the first and second objective optical element through the lens holder.

The optical pickup apparatus of the fourth embodiment can acquire the same effects as those of the optical pickup apparatus of the fourth embodiment.

A fifth embodiment of the invention is an optical pickup apparatus. The optical pickup apparatus comprises a first light source emitting a first light flux having wavelength of λ1, a second light source emitting a second light flux having wavelength of λ2, an light-converging optical system including a first objective optical element and a second objective optical element, and a lens holder to hold the first objective optical element and the second objective optical element. The first objective optical element is arranged in parallel with the second objective optical element so as to differ an optical axis of the first objective optical element from an optical axis of the second objective optical element, and at least one of the first objective optical element and the second objective optical element is a plastic lens.

The optical pickup apparatus of the fifth embodiment converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium, and the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium.

Further, in the optical pickup apparatus of the fifth embodiment, the plastic lens is made of a plastic material comprises a plastic resin and inorganic particles, which are dispersed in the plastic resin and have an average diameter of 30 nm or less.

In the optical pickup apparatus of the fifth embodiment, the inorganic particles having the average diameter of 30 nm or less are dispersed in the plastic lens. The refractive index changes of the inorganic particles, caused by a temperature change are generally smaller than those of resins. Accordingly, by using the objective optical elements each made of a plastic material which is a resin in which inorganic particles having an average diameter of 30 nm or less are dispersed, the refractive index changes can be suppressed with the transparency thereof being secured. As a result, the changes of the aberration caused by the temperature changes can be suppressed. Moreover, by raising the heat conduction ratio of each of the objective optical elements by dispersing the inorganic particles, the heat transmitted to each of the objective optical elements is diffused. Thereby, the deviation of the temperature on the optical surface can be suppressed, and the changes of the aberration caused by the temperature changes can be suppressed.

### BRIEF DESCRIPTION OF THE DRAWINGS

FIG. 1 is a schematic sectional view of an optical pickup apparatus according to the present embodiment;

FIG. 2 is a schematic sectional view of an optical pickup apparatus according to the present embodiment;

FIG. 3 is a perspective view of an objective lens unit used for the optical pickup apparatus of the embodiment;

FIG. 4 is a top view of the objective lens unit in the embodiment, showing a heat transfer state schematically;

FIG. 5 is a top view of an objective lens unit in a comparative example, showing the heat transfer state schematically similarly;

FIG. 6 is a top view of an objective lens unit in a modified example;

FIG. 7 is a perspective view showing an objective lens unit 20 in a second embodiment, which objective lens unit 20 can be used for the optical pickup apparatus of FIG. 1;

FIG. 8 is an enlarged sectional view taken in the direction of the arrows when the objective lens unit 20 of FIG. 7 is cut at a surface including the line VII-VII; and

FIG. 9 is an enlarged sectional view taken when the objective lens unit 20 of FIG. 7 is cut at a surface which includes an optical axis 02 and is perpendicular to the line VII-VII.

### DETAILED DESCRIPTION OF THE INVENTION

In the present invention, the description “a variation of each of a coma aberration and an astigmatism is not more than 0.02 λrms” means that the maximum value of the variations of a coma aberration and an astigmatism is 0.02 λrms or less when recording and/or reproducing are preformed by using a light source emitting a light flux of a wavelength λ by an optical pickup apparatus in comparison with the coma aberration and the astigmatism at the time of not driving the optical apparatus.

In the optical pickup apparatus mentioned above, it is preferable that the supporting member is driven by an actuator at the time of performing information recording and/or information reproducing to either of the first and the second information recording media. The more simplification of the optical pickup apparatus can be achieved by such a configuration in comparison with the case where the objective optical elements are severally driven by actuators. On the other hand, because the load of the actuator becomes larger in the case where the supporting member is driven by the actuator in comparison with the case where each actuator drives the objective optical elements, the generated heat quantity becomes larger. Consequently, the present invention is especially effective in such a case.

It is preferable that at least either of the first objective optical element and the second objective optical element of the optical pickup apparatus mentioned above is formed of a plastic resin in which inorganic particles having an average diameter of 30 nm or less are dispersed. It is preferable that a refractive index change |dn/dT| to temperature changes is less than 8×10⁻⁵ because the changes of an aberration can be suppressed even when a temperature distribution arises in an objective lens.

For example, the inorganic particles dispersed in a resin as the plastic material are not especially limited. The inorganic particles can be arbitrary selected from the inorganic particles enabling the achievement of the object of the present invention of reducing the rate of change of a refraction index (hereinafter referred to as |dn/dT|) caused by the temperature of an acquired thermoplastic resin composition, or of making the temperature distribution uniform by raising the heat conduction ratio of the plastic material. To put it concretely, oxide fine particles, metallic salt fine particles, semiconductor fine particles and the like are preferably used, and it is preferable to suitably select and use the fine particles which do not produce absorption, light emission, fluorescence and the like in the wavelength region to be used for the optical elements among the fine particles mentioned above.

As the oxide fine particles used in the present invention, there can be used the metallic oxides the metals of which are one kind or a plurality of kinds selected from the group consisting of Li, Na, Mg, Al, Si, K, Ca, Sc, Ti, V, Cr, Mn, Fe, Co, Ni, Cu, Zn, Rb, Sr, Y, Nb, Zr, Mo, Ag, Cd, In, Sn, Sb, Cs, Ba, La, Ta, Hf, W, Ir, Tl, Pb, Bi and rare earth metals. To put it concretely, there can be cited, for example, silicon oxide, titanium oxide, zinc oxide, aluminum oxide, zirconium oxide, hafnium oxide, niobium oxide, tantalum oxide, magnesium oxide, calcium oxide, strontium oxide, barium oxide, indium oxide, tin oxide, lead oxide, double oxides consisting of these oxides: lithium niobate, potassium niobate, lithium tantalate, aluminum magnesium oxide (MgAl₂O₄) and the like. Moreover, rare earth oxide can be also used as the oxide fine particles used in the present invention. To put it concretely, there can be cited scandium oxide, yttrium oxide, lanthanum oxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide, lutetium oxide and the like. As the metallic salt fine particles, there can be cited carbonate, phosphate, sulfate and the like. To put it concretely, there can be cited calcium carbonate, aluminum phosphate and the like.

Moreover, the semiconductor fine particles in the present invention mean the fine particles each having a semiconductor crystal composition. As concrete composition examples of the semiconductor crystal composition, there can be cited chemical elements of fourteenth group of a periodic table such as carbon, silicon, germanium, tin and the like; chemical elements of fifteenth group of the periodic table such as phosphorus (black phosphorus) and the like; chemical elements of sixteenth group of the periodic table such as selenium, tellurium and the like; the compounds consisting of a plurality of elements of the fourteenth group of the periodic table such as silicon carbide (SiC) and the like; the compounds of the elements of the fourteenth group of the periodic table and the elements of the sixteenth group of the periodic table such as tin oxide (IV) (SnO₂), tin sulfide (II, IV) (Sn(II)Sn(IV)S₃), tin sulfide (IV) (SnS₂), tin sulfide (II) (SnS), tin selenide (II) (SnSe), tin telluride (II) (SnTe), lead sulfide (II) (PbS), lead selenide (II) (PbSe), lead telluride (II) (PbTe) and the like; the compounds of the elements of the thirteenth group of the periodic table and the elements of the fifteenth group of the periodic table (or III-V compound semiconductors) such as boron nitride (BN), boron phosphide (BP), boron arsenide (BAs), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs), indium antimonide (InSb) and the like; the compounds of the elements of the thirteenth group of the periodic table and the elements of the sixteenth group of the periodic table such as aluminum sulfide (Al₂S₃), aluminum selenide (Al₂Se₃), gallium sulfide (Ga₂S₃), gallium selenide (Ga₂Se₃), gallium telluride (Ga₂Te₃), indium oxide (In₂O₃), indium sulfide (In₂S₃), indium selenide (In₂Se₃), indium telluride (In₂Te₃) and the like; the compounds of the elements of the thirteenth group of the periodic table and the elements of the seventeenth group of the periodic table such as thallium chloride (I) (TlCl), thallium bromide (I) (TlBr), thallium iodide (I) (TlI) and the like; the compounds of the elements of the twelfth group of the periodic table and the elements of the sixteenth group of the periodic table (or II-VI compound semiconductors) such as zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), mercury sulfide (HgS), mercury selenide (HgSe), mercury telluride (HgTe) and the like; the compounds of the elements of the fifteenth group of the periodic table and the elements of the sixteenth group of the periodic table such as arsenic sulfide (III) (As₂S₃), arsenic selenide (III) (As₂Se₃), arsenic telluride (III) (As₂Te₃), antimony sulfide (III) (Sb₂S₃), antimony selenide (III) (Sb₂Se₃), antimony telluride (III) (Sb₂Te₃), bismuth sulfide (III) (Bi₂S₃), bismuth selenide (III) (Bi₂Se₃), bismuth telluride (III) (Bi₂Te₃) and the like; the compounds of the elements of the eleventh group of the periodic table and the elements of the sixteenth group of the periodic table such as copper oxide (I) (Cu₂0), copper selenide (I) (Cu₂Se) and the like; the compounds of the elements of the eleventh group of the periodic table and the elements of the seventeenth group of the periodic table such as copper chloride (I) (CuCl), copper bromide (I) (CuBr), copper iodide (I) (CuI), silver chloride (AgCl), silver bromide (AgBr) and the like; the compounds of the elements of the tenth group of the periodic table and the elements of the sixteenth group of the periodic table such as nickel oxide (II) (NiO) and the like; the compounds of the elements of the ninth group of the periodic table and the elements of the sixteenth group of the periodic table such as cobalt oxide (II) (CoO), cobalt sulfide (II) (CoS) and the like; the compounds of the elements of the eighth group of the periodic table and the elements of the sixteenth group of the periodic table such as triiron tetraoxide (Fe₃O₄), iron sulfide (II) (FeS) and the like; the compounds of the elements of the seventh group of the periodic table and the elements of the sixteenth group of the periodic table such as manganous oxide (II) (MnO) and the like; the compounds of the elements of the sixth group of the periodic table and the elements of the sixteenth group of the periodic table such as molybdenum sulfide (IV) (MOS₂), tungstic oxide (IV) (WO₂) and the like; the compounds of the elements of the fifth group of the periodic table and the elements of the sixteenth group of the periodic table such as vanadium oxide (II) (VO), vanadium oxide (IV) (VO₂), tantalum oxide (V) (Ta₂O₅) and the like; the compounds of the elements of the fourth group of the periodic table and the elements of the sixteenth group of the periodic table such as titanium oxide (TiO₂, Ti₂O₅, Ti₂O₃, Ti₅O₉ and the like) and the like; the compounds of the elements of the second group of the periodic table and the elements of the sixteenth group of the periodic table such as magnesium sulfide (MgS), magnesium selenide (MgSe) and the like; chalcogen spinels such as cadmium oxide (II) chromium (III) (CdCr₂O₄), cadmium selenide (II) chromium (III) (CdCr₂Se₄), copper sulfide (II) chromium (III) (CuCr₂S₄), mercury selenide (II) chromium (III) (HgCr₂Se₄) and the like; and barium titanate (BaTiO₃) and the like. In addition, there are similarly exemplified semiconductor clusters the structure of which has been determined such as (BN)75(BF2)15F115 reported by G. Schmid et al., Adv. Mater., vol. 4, p. 494 (1991), and Cu₁₄₆Se₇₃(triethylphosphine)₂₂ reported by D. Fenske et al., Angew. Chem. Int. Ed. Engl., vol. 29, p. 1452 (1990).

The dn/dT of a thermoplastic resin generally has a negative value, that is, the refraction index becomes smaller as the temperature rises. Accordingly, in order to make the |dn/dT| of the thermoplastic resin composition small efficiently, it is preferable to disperse the fine particles each having a large dn/dT. In the case of using the fine particles each having a value of the same sign as that of the dn/dT of the thermoplastic resin, it is preferable that the absolute value of the dn/dT of the fine particles is smaller than the dn/dT of the thermoplastic resin to be used as a base material. Furthermore, the fine particles which severally have a dn/dT of the sign inverse to that of the thermoplastic resin used as the base material, namely the fine particles each having a dn/dT of a positive value, are preferably used. By dispersing the fine particles like this into a thermoplastic resin, the |dn/dT| of the thermoplastic resin composition can be effectively reduced by a small quantity. The dn/dT of the fine particles to be dispersed can be suitably selected based on the value of the dn/dT of the thermoplastic resin used as the base material. But, in the case of dispersing the fine particles into the thermoplastic resin used as the optical elements preferably, it is generally preferable that the dn/dT of the fine particles is larger than −20×10⁻⁶, and it is more preferably to be larger than −10×10⁻⁶. As the fine particles having a large dn/dT, for example, gallium nitride, zinc sulfide, zinc oxide, lithium niobate, lithium tantalate and the like are preferably used.

On the other hand, when fine particles are dispersed into a thermoplastic resin, it is desirable that the difference of the refractive indices of the thermoplastic resin and the fine particles is small. As a result of the inventors, it is found that, when the difference of the refraction indices of the thermoplastic resin and the fine particles to be dispersed is small, it is hard to cause scattering when light is transmitted. The larger the particles are at the time of dispersing the fine particles into the thermoplastic resin, the easier it is to cause the scattering at the time of the transmission of light. But, the inventors found that, when the difference of the refraction indices of the thermoplastic resin and the fine particles to be dispersed was small, the degree of the generation of the scattering of light was small even in the case of using the fine particles each having a relatively large diameter. The difference of the refraction indices of the thermoplastic resin and the fine particles to be dispersed is preferably within a range of from 0 to 0.3, and more preferably within a range of from 0 to 0.15.

The refraction indices of the thermoplastic resins which are preferably used as optical materials are within a range of from about 1.4 to about 1.6 in many cases, and, for example, silica (silicon oxide), calcium carbonate, aluminum phosphate, aluminum oxide, magnesium oxide, aluminum magnesium oxide and the like are preferably used as the materials to be dispersed into these thermoplastic resins. Moreover, the refraction indices of inorganic particles can be suitably controlled by using the composite particles containing a plurality of inorganic materials having different refraction indices.

Moreover, it was found that the dn/dT of a thermoplastic resin composition could be effectively reduced by dispersing the fine particles each having a relatively low refraction index by the research of the inventors. Although the details of the reason why the |dn/dT| of the thermoplastic resin composition in which the fine particles each having a low refraction index are dispersed becomes small are not known, it is presumed that the temperature changes of the volume fraction of the inorganic particles in a resin composition operate to reduce the |dn/dT| of the resin composition as the refraction index of the fine particles becomes smaller. As the fine particles having relatively low refraction indices, for example, silica (silicon oxide), calcium carbonate and aluminum phosphate are preferably used.

It is difficult to improve all of the reduction effect of the dn/dT, the optical transparency and a desired refraction index of a thermoplastic resin composition at the same time. The fine particles which are dispersed in the thermoplastic resin can be suitably selected in consideration of the magnitude of the dn/dT of the fine particles themselves, the difference between the dn/dT of the fine particles and that of the thermoplastic resin used as the base material, the refraction index of the fine particles and the like according to the characteristics required for the thermoplastic resin composition. Furthermore, it is preferable to suitably select and use the fine particles having a good compatibility with the thermoplastic resin used as the mother material, i.e. the dispersibility to the thermoplastic resin and the difficulty of causing scattering, for keeping optical transparency.

For example, when a cyclic olefin polymer, which is preferably used as an optical element, is used as the base material, silica is preferably used as the fine particles for reducing the |dn/dT| while keeping the optical transparency.

One kind of inorganic particles may be used for the fine particles, or a plurality of kinds of inorganic particles may be used for the fine particles together. By using a plurality of kinds of fine particles having different characters from one another, the needed characteristic can be also improved still more efficiently.

Moreover, the inorganic particles according to the present invention preferably have an average particle diameter within a range of from 1 nm to 30 nm both inclusive, and more preferably within a range of from 1 nm to 20 nm both inclusive, and still more preferably within a range of from 1 nm to 10 nm both inclusive. When the average particle diameter is under 1 nm, the dispersion of the inorganic Particles becomes difficult, and it is apprehended that a desired performance cannot be acquired. Consequently, the average diameter is preferably 1 nm or more. Moreover, when the average particle diameter exceeds 30 nm, the obtained thermoplastic material composition becomes cloudy or the like to lower the transparency, and then it is apprehended that the light transmittance becomes less than 70%. Consequently, the average particle diameter is preferably 30 nm or less. The average particle diameter hereupon means a volume average value of a diameter of each particle when it is converted to a sphere having the same volume (a sphere conversion particle diameter).

Furthermore, although the forms of the inorganic Particles are not especially limited, spherical fine particles are suitably used. To put it concretely, it is Preferable that the value of the minimum diameter of the fine Particles (the minimum value of the distances between the tangential lines in the case of drawing two tangential lines which touch the outer periphery of each of the fine Particles)/the maximum diameter (the maximum value of the distances between the tangential lines in the case of drawing the two tangential lines which touch the outer periphery of each of the fine particles) is within a range of from 0.5 to 1.0, and it is more preferable that the value is within a range of from 0.7 to 1.0.

Moreover, although the distribution of the particle diameters are also not restricted especially, in order to reveal the effects of the present invention more efficiently, the particles having a relative narrow distribution are suitably used rather than the particles having a wide distribution.

In the optical pickup apparatus mentioned above, either of the first objective optical element and the second objective optical element can be made of a glass lens. Although the cost of the glass lens is higher compared with that of a plastic lens, because performance changes owing to temperature changes are small, the configuration is preferable in which the lens used recoding and/or reproducing of a high density recording medium having a high need to suppress the changes of aberrations is made as the glass lens and the other lens is made as a plastic lens. In the case of using the glass lens, it is preferable that the refractive index change |dn/dT| is under 5×10⁻⁵ against temperature changes because aberration changes can be suppressed even when the temperature distribution arises.

It is preferable that the optical pickup apparatus mentioned above further includes a third light source emitting a third light flux having a wavelength of λ3, and that the optical pickup apparatus performs information recording and/or information reproducing by converging the third light flux onto the information recording surface of a third optical information recording medium through a protection layer having an thickness of t3 (t3>t1 or t3>t2) using the first or the second objective optical element. According to such a configuration, information recording and/or information reproducing can be performed to, for example, any of a high density DVD, a DVD and a CD. Moreover, in this case, it is preferable that the objective optical element converging the third light flux includes at least one diffractive lens. It is required for the objective optical element converging the third light flux to converge the light fluxes from two light sources onto different optical information recording media, respectively, and a spherical aberration originated in the difference of wavelengths and/or the difference of the thicknesses of the protective substrates of the optical information recording media arises. The spherical aberration can be reduced by correcting the spherical aberration with the diffractive lens.

In the present specification, the objective optical element (also referred to as an objective lens) indicates an Optical element having a converging operation which optical element is disposed, to be opposed to an optical information recording medium at a position nearest to the side of the optical information recording medium in the state in which the optical information recording medium is loaded in the optical pickup apparatus. Further it is supposed that the objective optical element indicates the optical element which can operate at least in the optical axis direction by an actuator together with the optical element mentioned above.

### PREFERRED EMBODIMENTS OF THE INVENTION

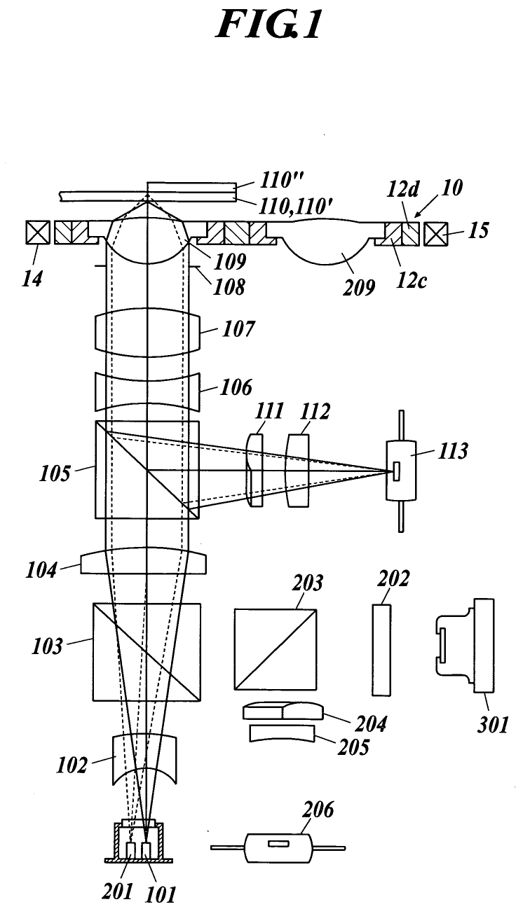

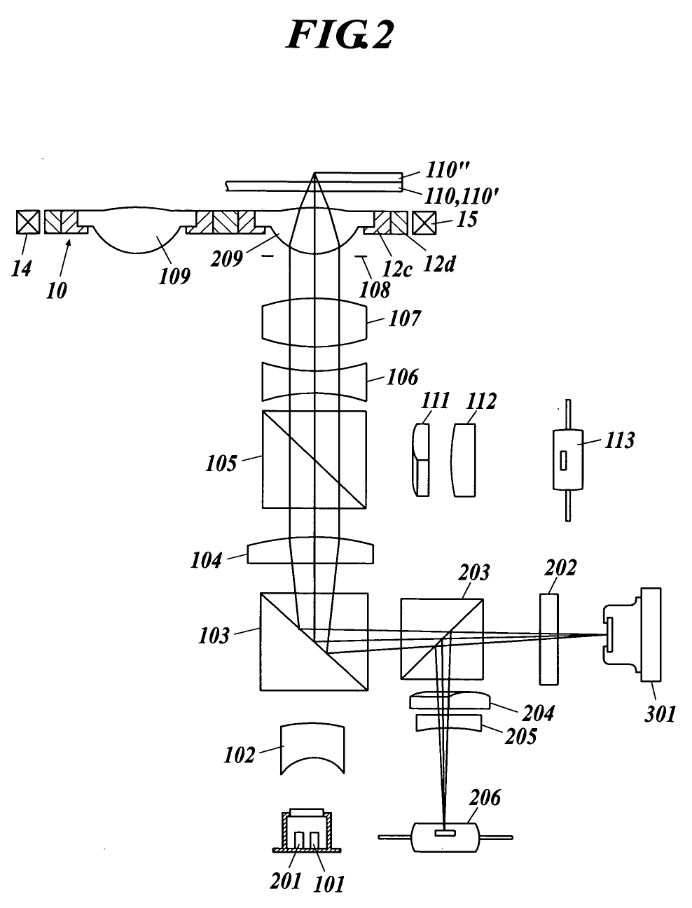

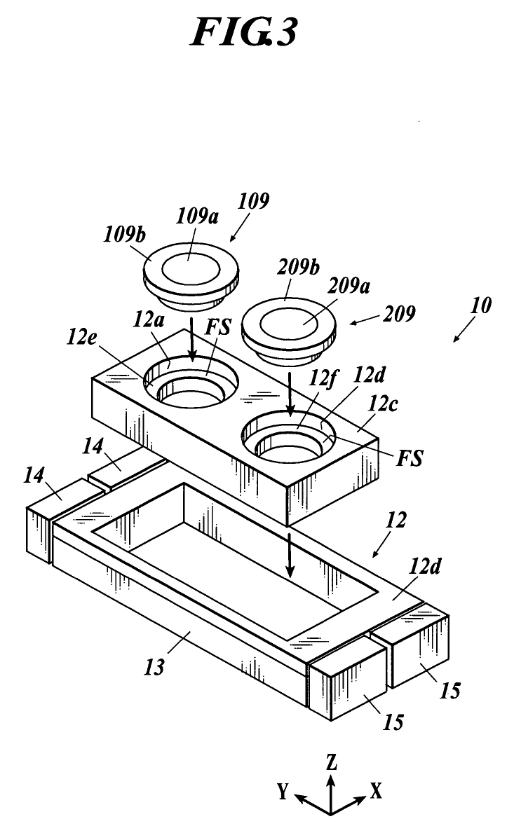

In the following, the present invention is described still in detail with reference to the attached drawings. FIG. 1 and FIG. 2 are schematic sectional views each showing an optical pickup apparatus capable of performing information recording and/or information reproducing to all of a high density DVD (also referred to as a first optical disc), a conventional DVD (also referred to as a second optical disc) and a CD (also referred to as a third optical disc). FIG. 3 is a perspective view showing an objective lens unit used for the optical pickup apparatus of the present embodiment.

First, an objective lens unit 10 is described. The objective lens unit 10 is composed of an objective lens 109 and an objective lens 209 for light-converging, a lens holder main body 12 holding the objective lenses 109 and 209, a focusing coil 13, which is formed on the outer periphery of the lens holder main body 12 and is a constituent element of a focusing actuator, and tracking coils 14 and 15, which are arranged on the both ends of the lens holder main body 12 in the lengthwise direction thereof and are constituent elements of a tracking actuator. In addition, the lens holder main body 12 is supported by a not shown wire in a state of being minutely displaceable to the side of a head main body, and the tracking coils 14 and 15 are configured to be arranged at suitable positions to be opposed to a magnet or a yoke (not shown). Moreover, the objective lens unit 10 is equipped with a coil drive circuit (not shown) to move the lens holder main body 12 into a Z direction parallel to an optical axis or an X direction perpendicular to the Z direction together with the objective lenses 109 and 209 by a desired quantity by electrifying each of the coils 13, 14 and 15 disposed in the magnetic field formed by the magnet and the like mentioned above.

Here, the objective lenses 109 and 209 are biconvex lenses each made of a plastic, and have annular flange portions 109b and 209b on the outer periphery of circular objective lens main bodies 109a and 209a. In addition, although a couple of optical surfaces formed on the objective lens main bodies 109a and 209a can be made to consist of, for example, aspherical surfaces or the like, the optical surfaces are not limited to mere curved surfaces. For example, in the case of a compatible type optical head capable of information recording and/or information reproducing in conformity to a plurality of standards of a CD, a DVD, a high density optical dis and the like, the optical surfaces of the objective lens main bodies 109a and 209a can be made to have a phase structure such as a diffraction structure and the like. Furthermore, these optical surfaces can be also divided into peculiar orbicular zone structures.

The lens holder main body 12 has an internal holding member 12c including circular aperture portions 12a and 12b at the center thereof, and an external holding member 12d supporting the periphery of the internal holding member 12c. The internal holding member 12c is fixed into the aperture formed in the external holding member 12 in the state of being fit into the aperture by adhesion. Both of the holding members 12c and 12d are molded components made of plastic materials, and, the material of the internal holding member 12c has a heat conduction ratio lower than that of the external holding member 12d. An annular supporting portion 12e is formed to form a step on the inner periphery of the aperture portion 12a formed in the internal holding member 12c, and an annular supporting portion 12f is formed to form a step on the inner periphery of the aperture portion 12b formed in the internal holding member 12c. The annular supporting portions 12e and 12f have flat top surfaces FS, and can support the annular flange portions 109b and 209b formed on the output periphery of the objective lenses 109 and 209 from the lower side.

Next, the optical pickup apparatus of the present embodiment is described. In the present embodiment shown in FIG. 1, at the time of performing information recording and/or information reproducing to a first optical disc 110 and a second optical disc 110′, it is supposed that the objective lens unit 10 is moved, and that the objective lens 109 is inserted into an optical path as shown in FIG. 1. That is, in the present embodiment, the objective lens 109 is shared by the first optical disc 110 and the second optical disc 110′. Moreover, a first semiconductor laser 101 and a second semiconductor laser 201 are attached on the same substrate, and constitute a single unit called as the so-called two-laser one-package.

First, the beam shape of a light flux emitted from the fist semiconductor laser 101 (having a wavelength of λ1=380 nm to 450 nm) as the first light source is corrected by a beam shaper 102, and the light flux passes through a first beam splitter 103. After the light flux having passed through the first beam splitter 103 is made to be a parallel light flux by a collimator 104, the parallel light flux passes through a second beam splitter 105, and enters a beam expander including optical elements 106 and 107. The beam expander (106, 107), in which at least one (preferably the optical element 106) of the optical elements 106 and 107 can move into the optical axis direction, changes (hereupon expands) the light flux diameter of the parallel light flux, and then has the function of correcting a chromatic aberration and a spherical aberration. In particular, a diffraction structure (diffraction orbicular zones) is formed on the optical surface of the other optical element 107 of the beam expander, and is configured to perform the chromatic aberration correction of the light flux emitted from the first semiconductor laser 101 by this. The diffraction structure for the chromatic aberration correction may be formed not only on the optical element 107 but also on another optical element (e.g. the collimator 104) or the like. In addition, the chromatic aberration correction function may be achieved by a phase structure other than the diffraction structure.

By providing the beam expander (106, 107) as mentioned above, the chromatic aberration correction and the spherical aberration correction can be performed, and for example, if the high density DVD is a type of including two layers of the information recording surfaces, the selection of the information recording surface can be also performed by moving the optical element 106 into the optical axis direction. In addition, the chromatic aberration correction optical element and the means for suppressing the spherical aberration may not be the beam expander (106, 107), but may be a diffraction structure provided on the objective lens 109 (209) and the like.

In FIG. 1, the light flux having transmitted the beam expander (106, 107) passes an iris 108, and is converged onto the information recording surface of the first optical disc 110 through the protection layer (having a thickness of t1=0 mm to 0.7 mm, preferably, 0.1 mm or 0.6 mm) of the first optical disc 110 by the objective lens 109, which is an objective optical element consisting of only a refractive surface. The converged light flux forms a converged spot on the information recording surface. In addition, although the objective lens 109 may be made of glass as a material thereof, the limitation of the required optical characteristics is relaxed because the aberration deterioration caused by environmental changes and the like can be arbitrary corrected with the beam expander (106, 107). Accordingly the plastic material, which is more inexpensive, can be used as the material of the objective lens 109.

The light flux which has been modulated by information pits on the information recording surface and reflected by the information pits again transmits the objective lens 109, the iris 108 and the beam expander (107, 106) to be reflected by the second beam splitter 105. An astigmatism is added to the light flux reflected by the second beam splitter 105 by a cylindrical lens 111, and the light flux transmits a sensor lens 112 to enter the light receiving surface of a photodetector 113. Accordingly, a read signal of the information recorded on the first optical disc 110 can be acquired by using the output signal of the photodetector 113.

Moreover, in-focus detection and track detection are performed by detecting a light quantity change caused by a shape change and a position change of the spot on the photodetector 113. The optical pickup apparatus is configured in order that the focusing actuator and the tracking actuator of the objective lens unit 10 may move the objective lens 109 in a body based on the detection to make the light flux from the first semiconductor laser 101 form an image on the information recording surface of the first optical disc 110.

Furthermore, in FIG. 1, the light flux emitted from the second semiconductor laser 201 (having the wavelength of 2=600 nm to 700 nm) as the second light source is subjected to the correction of the beam shape thereof by the beam shaper 102, and passes through the first beam splitter 103 to be a parallel light flux while the light flux diameter thereof is narrowed down by the collimator 104. The parallel light flux then passes through the second beam splitter 105, and enters the beam expander (106, 107). As mentioned above, the beam expander (106, 107) can perform chromatic aberration correction and spherical aberration correction. In addition, dichroic coat is performed to the iris 108 as means for adjusting the numeral aperture, and thus the passing region of the light flux is limited according to the wavelength. Thereby, for example, as for the light flux from the first semiconductor laser 101, the numerical aperture NA of the objective lens 109 is realized to be 0.65. As for the light flux from the second semiconductor laser 201, the numerical aperture NA of the objective lens 109 is realized to be 0.65. As for the light flux from a third semiconductor laser 301, the numerical aperture NA of the objective lens 109 is realized to be 0.45. However, the combination of the numerical apertures is not restricted to such a combination.

In FIG. 1, the light flux which has transmitted the beam expander (106, 107) passes through the iris 108 in the state of the parallel light flux. Then, the parallel light flux is converged onto the information recording surface of the second optical disc 110′ through the protection layer (having a thickness of t2=0.5 mm to 0.7 mm, preferably 0.6 mm) of the second optical disc 110′, and the converged light flux forms a converged spot thereon.

The light flux which has been modulated and reflected by the information pits on the information recording surface again transmits the objective lens 109, the iris 108 and the beam expander (107, 106), and is reflected by the second beam splitter 105. An astigmatism is given to the reflected light flux by the cylindrical lens 111. The light flux then transmits the sensor lens 112 to enter the light receiving surface of the photodetector 113. Accordingly, the read signal of the information recorded on the first optical disc 110 can be acquired by using the output signal of the photodetector 113.

Moreover, a light quantity change caused by the shape change and the position change of the spot on the photodetector 113 is detected, and thereby in-focus detection and track detection are performed. The optical pickup apparatus is configured in order that the focusing actuator and the tracking actuator of the objective lens unit 10 may move the objective lens 109 in one body based on the detection to make the light flux from the second semiconductor laser 201 form an image on the information recording surface of the second optical disc 110′.

Furthermore, as shown in FIG. 2, at the time of performing information recording and/or information reproducing to a third optical disc 110″, the objective lens unit 10 is moved to insert the objective lens 209 into the optical path. That is, in the present embodiment, the objective lens 209 is used only for the third optical disc 110″.

In FIG. 2, the light flux emitted from the third semiconductor laser 301 (having a wavelength of λ3=770 nm to 830 nm) as the third light source passes through a λ/4 wavelength plate 202 and a third beam splitter 203, and is reflected by the first beam splitter 103. Then, the reflected light flux is changed to a parallel light flux while the light flux diameter is narrowed down by the collimator 104, and the parallel light flux passes through the second beam splitter 105. Then, the parallel light flux enters the beam expander (106, 107), and is converted into a limited diverging light flux having an angle of divergence. Similarly, the beam expander (106, 107) can perform the chromatic aberration correction and the spherical aberration correction.

In FIG. 2, the light flux which has transmitted the beam expander (106, 107) passes through the iris 108 in a limited divergent state, and then is converged onto the information recording surface of the third optical disc 110″ through the protection layer (having a thickness of t3=1.1 mm to 1.3 mm, preferably 1.2 mm) of the third optical disc 110″. The converged light flux forms a converged spot on the information recording surface.

The light flux which has been modulated and reflected by the information pits on the information recording surface again passes through the objective lens 209, the iris 108, the beam expander (107, 106), the second beam splitter 105 and the collimator 104, and is reflected by the first beam splitter 103. Successively, the reflected light flux is reflected by the third beam splitter 203, and then an astigmatism is given to the reflected light flux by a cylindrical lens 204. The light flux then transmits a sensor lens 205 to enter the light receiving surface of a photodetector 206, and accordingly the read signal of the information recorded on the third optical disc 110″ can be acquired by using the output signal of the photodetector 206.

Moreover, a light quantity change caused by the shape change and the position change of the spot on the photodetector 206 is detected, and in-focus detection and track detection are performed. The optical pickup apparatus is configured in order that the focusing actuator and the tracking actuator of the objective lens unit 10 may move the objective lens 209 in a body based on the detection to make the light flux from the third semiconductor laser 301 form an image on the information recording surface of the third optical disc 110″.

In addition, in the above embodiment, a liquid crystal optical element can be also used in place of the beam expander, and thereby the main heat sources can be limited to the focusing actuator and the tracking actuator. Thus, the heating of the objective lenses can be suppressed.

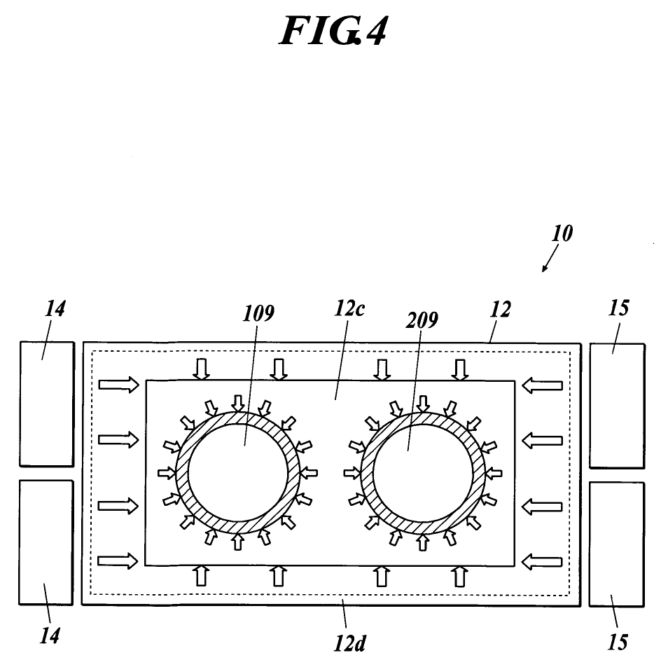

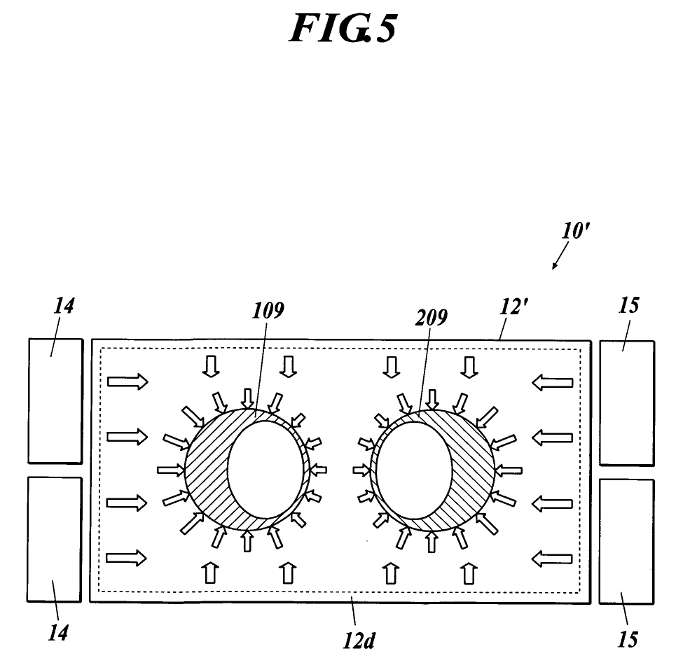

FIG. 4 is a top view of the objective lens unit according to the present embodiment, and is a view schematically showing a heat transfer state. FIG. 5 is a top view of an objective lens unit according to a comparative example, and is similarly a view schematically showing a heat transfer state. In each of the views, the magnitudes of the heat transfer quantities are shown by the lengths of arrows. In the comparative example shown in FIG. 5, an internal holding member and an external holding member of a lens holder main body 12′ are formed of the same resin to be one body. The configurations of the objective lens units shown in FIGS. 4 and 5 are the same as each other except for the configurations of the internal holding members and the external holding members.

Here, as shown in FIG. 5, a part of the heat generated by the focusing coil 13 and the tracking coils 14 and 15, which are heat sources disposed in the circumference of the lens holder main body 12′ is radiated into the peripheral atmosphere, but the remainder transfers to the lens holder main body 12′ as shown by the arrows. As a result, heat transfers to the objective lenses 109 and 209 through the lens holder main body 12′, and thereby a temperature distribution generated in the direction perpendicular to the optical axes in the objective lenses 109 and 209 is divided into high temperature regions shown by being hatched and low temperature regions shown by being voided in the view. Thereby, the deformations of the optical surfaces which are not point symmetry to the optical axes are caused, and it is apprehended that aberration deterioration is produced.

On the other hand, as shown in FIG. 4, because the lens holder main body 12 is composed of the internal holding member 12c and the external holding member 12d and further the material of the internal holding member 12c has a heat conduction ratio lower than that of the material of the external holding member 12d, the heat having transferred to the lens holder main body 12 is radiated from the surface of the external holding member 12, and is shielded by the internal holding member 12c to be made to be uniform. Thus, a little quantity of the uniform heat is transferred to the periphery of the objective lenses 109 and 209. Consequently, in the objective lenses 109 and 209, the high temperature regions shown by being hatched in the view are restricted to narrow regions in the neighborhood of the flange portions around almost the optical axes, and the temperature differences between the high temperature regions and the low temperature regions shown by being voided also decrease.

By combining the heat radiation of the external holding member 12d and the heat shield of the internal holding member 12c to be used, the changes of the spherical aberration, the coma aberration and the astigmatism are made to be suppressed into a fixed range (hereupon ±0.02 λ1 rms or less, or ±0.02 λ2 rms or less) during a change from the temperature distributions arising into the direction perpendicular to the optical axes of the objective lenses 109 and 205 and/or in the optical axis directions before use to the temperature distribution at the time of use. Because the aberration changes are suppressed in this way and the deformations of the optical surfaces can be made to be point symmetry even if the deformations arise, information recording and/or information reproducing can be suitably performed to any of the optical discs.

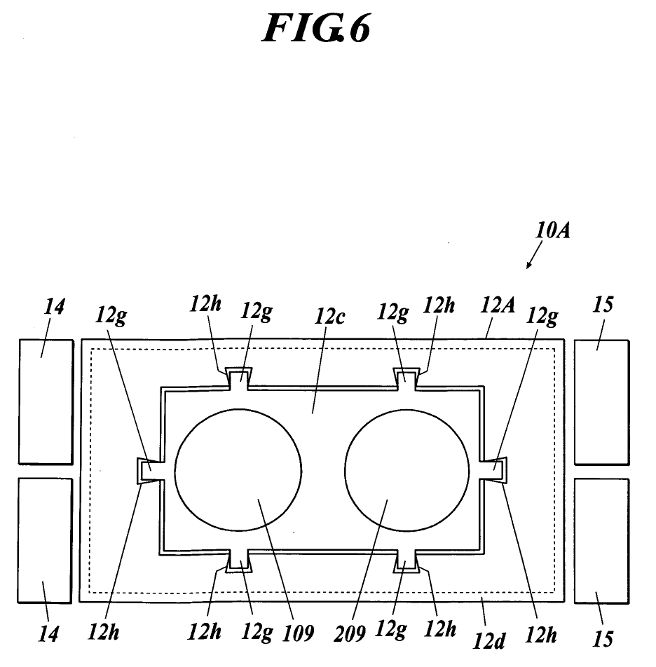

FIG. 6 is a top view of an objective lens unit according to a modified example. In the case of the objective lens unit 10A, four projections 12g are formed on the periphery of the internal holding member 12c constituting a lens holding main body 12A, and four recessed portions 12h are formed on the side of the inner periphery of the aperture of the external holding member 12d. When the internal holding member 12c is inserted into the aperture of the external holding member 12d, each of the projections 12g is fit into each of the recessed portions 12h. For example, the thermal expansion coefficient of the internal holding member 12c is made to be small, and the thermal expansion coefficient of the external holding member 12d is made to be large. Both of the members 12c and 12d are then made to be in a high temperature state, and the internal holding member 12c is fit into the aperture of the external holding member 12d. Then, by returning temperatures of the members 12c and 12d to the ordinary temperature, the interference fit is achieved between the corresponding projections 12g and the recessed portions 12h, and the internal holding member 12c is fixed in the external holding member 12d.

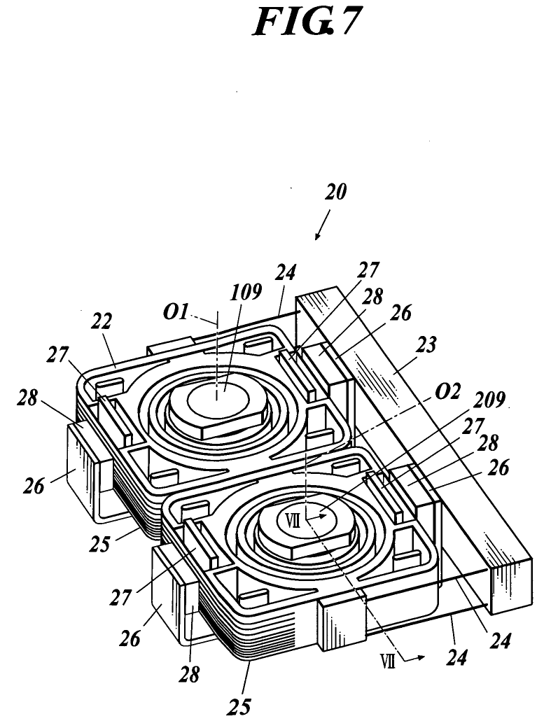

FIG. 7 is a perspective view showing an objective lens unit 20 according to a second embodiment capable of being used for the optical pickup apparatus shown in FIG. 1. In FIG. 6, the objective lenses 109 and 209 having the oval external forms which has optical axes O1 and O2 and are cut at two positions in their flange portions are supported by and are adhered to a common lens holder main body 22. The lens holder main body 22 is supported by four flexible wires 24 extending from a supporting holder 23, and the lens holder main body 22 is enabled to move within a predetermined range by using the wires 24 as suspensions.

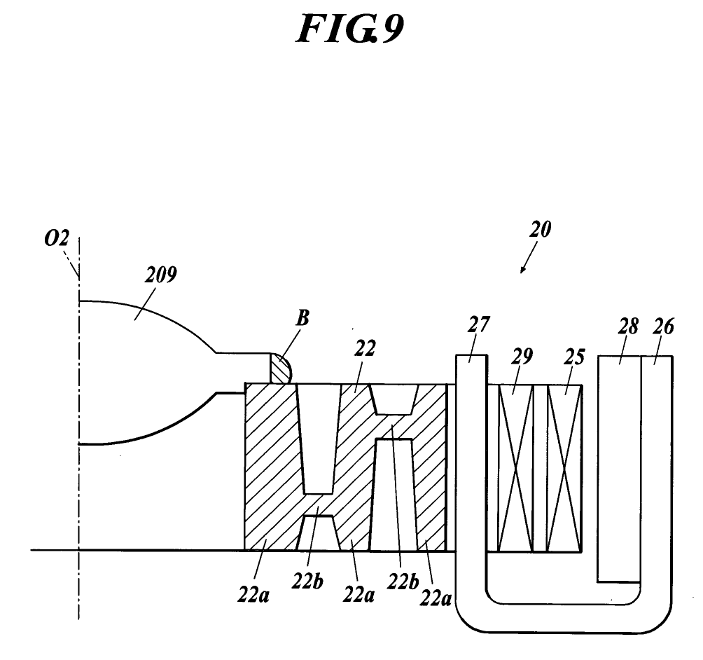

A focus driving coil 25 is wound around the outer periphery of the lens holder main body 22, and a tracking driving coil 29 (see FIG. 9) is disposed in magnetic circuits each composed of an external yoke 26, an internal yoke 27 and a magnet 28. By supplying electric power to these coils, which are constituent elements of actuators, the lens holder main body 22 can rock in two directions of the directions of the optical axes O1, O2 and the direction perpendicular to the optical axes. Moreover, electric power is supplied to these coils through the wires 24.

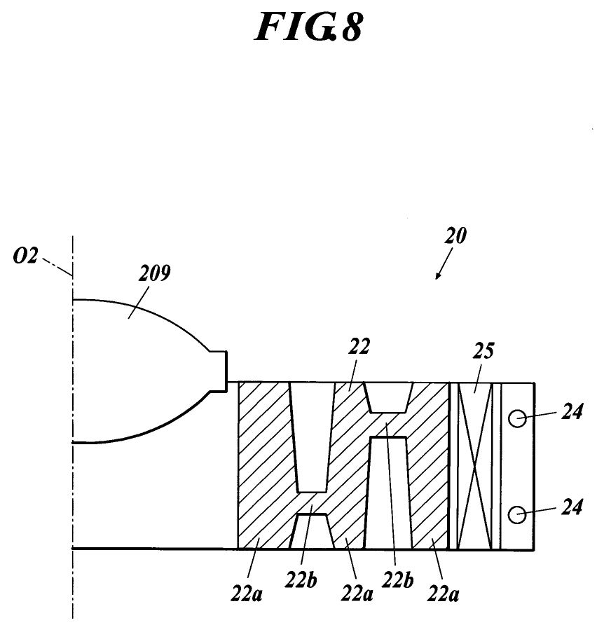

FIG. 8 is an enlarged sectional view of cutting the objective lens unit 20 of FIG. 7 on a surface including a line VII-VII to be seen from arrow directions. FIG. 9 is an enlarged sectional view of cutting the objective lens unit 20 on a surface which includes the optical axis O2 and is perpendicular to the line VII-VII to be seen from the arrow directions. As shown in FIG. 9, the objective lens 209 is adhered to the flange portion of the lens holder main body 22 with an ultraviolet curing type adhesive B.

Because the lens holder main body 22 is formed by connecting adjoining fins 22a, which are severally shaped in a square pillar and formed to enclose the periphery of the optical axis O2 several times over, to each other with plate portions 22b in radial directions as shown in the views, the lens holder main body 22 is formed so that the surface area thereof may be enlarged as much as possible. That is, the heat generated from the focus driving coil 25 and the tracking driving coil 29 is radiated by the projections enlarging the surface area, and the heat quantity transmitting to the objective lens 209 can be suppressed to the minimum quantity. Consequently, the changes of the spherical aberration, the coma aberration and the astigmatism can be suppressed within a fixed range (hereupon ±0.2 λ2 rms or less) during the period of a change from the temperature distribution of the optical surface of the objective optical element 209 before use to the temperature distribution at the time of use. Moreover, by adopting such a shape, the metal mold for molding the lens holder main body 22 can be easily produced to have a single configuration, and can acquire the lens holder main body 22 without raising the cost thereof.

Moreover, it is desirable that the adjoining plate portions 22b positioned between the respective fins 22a are formed to be shifted from each other in the optical axis direction and not to be located on the same plane as shown in the views. Such a configuration is effective for making the paths of the conduction of the heat generated from the focus driving coil 25 and the tracking driving coil 29 be complicated to enlarge the heat conduction distance to the objective lens 209. Moreover, apertures may be formed in the fins 22a and the plate portions 22b within a range not to influence their rigidity. The configuration of supporting the objective lens 109 is the same as that of supporting the objective lens 209.

Furthermore, as another embodiment, in the objective lens unit 10′ shown in FIG. 5, at least one of the objective lenses 109 and 209 may be formed of a plastic resin having a dn/dT under 8×10⁻⁵ in which inorganic particles each having a particle diameter of 30 nm or less are dispersed. Alternatively, at least one of the objective lenses 109 and 209 may be formed of a glass having a dn/dT under 5×10⁻⁵. In such cases, because the dn/dT's are smaller than that of normal plastic lens, even if a deviation arises in the temperature distribution of the optical surface, information recording and/or information reproducing can be suitably performed to any optical discs by suppressing the local refractive index change.

Although the present invention has been described with reference to the embodiments above, the present invention should not be interpreted to be limited to the embodiments described above, and it is a matter of course that changes and improvements can be suitably performed. For example, in the case where the objective lens is composed of a plurality of optical elements, the present invention can be applied even if the temperature of an optical element located at a position nearest to a heat source, the temperatures of the remainder optical elements, and the temperature distributions produced in the direction perpendicular to the optical axis and/or the optical axis direction are remarkably different from one another.

According to the present invention, it is possible to provide an optical pickup apparatus capable of performing information recording and/or information reproducing suitably to different optical information recording media by using two objective optical elements.

The present U.S. patent application claims a priority under the Paris Convention of Japanese patent application No. 2005-256400 filed on Sep. 5, 2005, and shall be a basis of correction of an incorrect translation.

What is claimed is:

1. An optical pickup apparatus comprising:
a first light source emitting a first light flux having wavelength of λ1;
a second light source emitting a second light flux having wavelength of λ2;
an light-converging optical system including a first objective optical element and a second objective optical element, the first objective optical element being arranged in parallel with the second objective optical element so as to differ an optical axis of the first objective optical element from an optical axis of the second objective optical element, and at least one of the first objective optical element and the second objective optical element is a plastic lens; and
a lens holder to hold the first objective optical element and the second objective optical element,
wherein when the optical pickup apparatus converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium, a variation of each of a coma aberration and an astigmatism is not more than 0.02 λ1 rms, and
wherein when the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium, a variation of each of a coma aberration and an astigmatism is not more than 0.02 λ2 rms.

2. The optical pickup apparatus of claim 1, wherein the lens holder is moved by an actuator when the information recording and/or information reproducing of the first information recording medium or the second information recording medium is conducted.

3. The optical pickup apparatus of claim 1, wherein the lens holder comprises a internal holding member to directly hold the first and second objective optical elements and a external holding member to hold the internal lens holding member, and
wherein a heat conduction ratio of the internal holding member and a heat conduction ratio of the external holding member is different from each other.

4. The optical pickup apparatus of claim 3, wherein the heat conduction ratio of the internal holding member is smaller than the heat conduction ratio of the external holding member.

5. The optical pickup apparatus of claim 1, wherein the lens holder has a radiating fin.

6. The optical pickup apparatus of claim 1, wherein the lens holder has a radiating means for reducing heat transfer from an external heat source to the first and second objective optical element through the lens holder.

7. The optical pickup apparatus of claim 1, wherein the plastic lens is made of a plastic material comprises a plastic resin and inorganic particles, which are dispersed in the plastic resin and have an average diameter of 30 nm or less.

8. The optical pickup apparatus of claim 7, wherein a refractive index change |dn/dT| to a temperature change is 8×10⁻⁵/° C. or less.

9. The optical pickup apparatus of claim 7, wherein the heat conduction ratio of the plastic material is smaller than the heat conduction ratio of the plastic resin.

10. The optical pickup apparatus of claim 1, wherein the wavelength λ1 of the first light flux is shorter than the wavelength λ2 of the second light flux.

11. The optical pickup apparatus of claim 1, wherein at least one of the first and second objective optical element includes at least a glass lens.

12. The optical pickup apparatus of claim 1, wherein the optical pickup apparatus further comprising a third light source emitting a third light flux having wavelength of λ3, and the optical pickup apparatus converges the third light flux onto a third information recording surface of a third information recording medium through a third protective substrate, which has a thickness of t3 and is provided on the third information recording surface, with utilizing one of the first and second objective optical element for conducting information recording and/or information reproducing of the third information recording medium.

13. The optical pickup apparatus of claim 12, wherein the first objective optical element is utilized for converging the third light flux,
wherein the first objective optical element includes at least a diffractive lens, and
wherein the first objective optical element compensates a spherical aberration due to at least one of a difference in the thicknesses of the first protective substrate and the third protective substrate and a difference in the wavelengths of the first light flux and the third light flux.

14. The optical pickup apparatus of claim 12, wherein the second objective optical element is utilized for converging the third light flux,
wherein the second objective optical element includes at least a diffractive lens, and
wherein the second objective optical element compensates a spherical aberration due to at least one of a difference in the thicknesses of the second protective substrate and the third protective substrate and a difference in the wavelengths of the second light flux and the third light flux.

15. An optical pickup apparatus comprising:
a first light source emitting a first light flux having wavelength of λ1;
a second light source emitting a second light flux having wavelength of λ2;
an light-converging optical system including a first objective optical element and a second objective optical element, the first objective optical element being arranged in parallel with the second objective optical element so as to differ an optical axis of the first objective optical element from an optical axis of the second objective optical element, and at least one of the first objective optical element and the second objective optical element is a plastic lens; and
a lens holder to hold the first objective optical element and the second objective optical element,
wherein the optical pickup apparatus converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium,
wherein the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium, and
wherein the lens holder comprises a internal holding member to directly hold the first and second objective optical elements and a external holding member to hold the internal lens holding member, and
wherein a heat conduction ratio of the internal holding member and a heat conduction ratio of the external holding member is different from each other.

16. The optical pickup apparatus of claim 15, wherein the heat conduction ratio of the internal holding member is smaller than the heat conduction ratio of the external holding member.

17. An optical pickup apparatus comprising:
a first light source emitting a first light flux having wavelength of λ1;
a second light source emitting a second light flux having wavelength of λ2;
an light-converging optical system including a first objective optical element and a second objective optical element, the first objective optical element being arranged in parallel with the second objective optical element so as to differ an optical axis of the first objective optical element from an optical axis of the second objective optical element, and at least one of the first objective optical element and the second objective optical element is a plastic lens; and
a lens holder to hold the first objective optical element and the second objective optical element,
wherein the optical pickup apparatus converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium,
wherein the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium, and
wherein the lens holder has a radiating fin.

18. An optical pickup apparatus comprising:
a first light source emitting a first light flux having wavelength of λ1;
a second light source emitting a second light flux having wavelength of λ2;
an light-converging optical system including a first objective optical element and a second objective optical element, the first objective optical element being arranged in parallel with the second objective optical element so as to differ an optical axis of the first objective optical element from an optical axis of the second objective optical element, and at least one of the first objective optical element and the second objective optical element is a plastic lens; and
a lens holder to hold the first objective optical element and the second objective optical element,
wherein the optical pickup apparatus converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium,
wherein the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium, and
wherein the lens holder has a radiating means for reducing heat transfer from aft external heat source to the first and second objective optical element through the lens holder.

19. An optical pickup apparatus comprising:
a first light source emitting a first light flux having wavelength of λ1;
a second light source emitting a second light flux having wavelength of λ2;
an light-converging optical system including a first objective optical element and a second objective optical element, the first objective optical element being arranged in parallel with the second objective optical element so as to differ an optical axis of the first objective optical element from an optical axis of the second objective optical element, and at least one of the first objective optical element and the second objective optical element is a plastic lens; and
a lens holder to hold the first objective optical element and the second objective optical element,
wherein the optical pickup apparatus converges the first light flux onto a first information recording surface of a first information recording medium through a first protective substrate, which has a thickness of t1 and is provided on the first information recording surface, with utilizing the first objective optical element for conducting information recording and/or information reproducing of the first information recording medium,
wherein the optical pickup apparatus converges the second light flux onto a second information recording surface of a second information recording medium through a second protective substrate, which has a thickness of t2 and is provided on the second information recording surface, with utilizing the second objective optical element for conducting information recording and/or information reproducing of the second information recording medium, and
wherein the plastic lens is made of a plastic material comprises a plastic resin and inorganic particles, which are dispersed in the plastic resin and have an average diameter of 30 nm or less.

20. The optical pickup apparatus of claim 19, wherein a refractive index change |dn/dT| to a temperature change is 8×10⁻⁵/° C. or less.

21. The optical pickup apparatus of claim 19, wherein the heat conduction ratio of the plastic material is smaller than the heat conduction ratio of the plastic resin.
